(19) United States
(12) Patent Application Publication
(10) Pub. No.: US 2011/0109002 A1
(43) Pub. Date: May 12, 2011

(54) Multi-Part Tube And Method Of Assembly

(75) Inventors: Kevin Adams, New South Wales (AU); Mariano Villaescusa, New South Wales (AU)

(73) Assignee: EZYTUBE PTY LIMITED, Ingleburn, New South Wales (AU)

(21) Appl. No.: 12/809,077

(22) PCT Filed: Dec. 19, 2008
(86) PCT No.: PCT/AU2008/001890

§ 371 Date: Oct. 29, 2010

(30) Foreign Application Priority Data
Dec. 21, 2007 (AU) 2007907065

(51) Int. Cl. B28B 1/14; B28B 7/36; B28B 7/04; B28B 7/26

(52) U.S. Cl. 264/32; 249/112; 249/171; 249/168

(57) ABSTRACT

A concrete formwork tube, said tube including: an internal lining; an external lining; and two or more complementary mould segments, adapted to be received between said external and internal lining; each mould segment having an inner face and an outer face; said mould segments, when assembled and substantially restrained by the external lining from relative movement, defining a moulding cavity open towards an upper and a lower end of the formwork; and at least one locking segment, said locking segment adapted to be disposed between two of said mould segments, thereby to tighten the fit of the assembled mould segments inside the external lining.

### FIELD OF THE INVENTION

The field of the invention relates to the manufacture, assembly and use of concrete formwork tubes used as moulds (also commonly known as forms) for the construction of concrete columns.

### BACKGROUND OF THE INVENTION

Re-usable concrete formwork moulds are known in the art. These normally consist of two- or multi-part re-usable steel or fibreglass mould components that can be braced together to form a casting cavity corresponding in shape to the desired building element. These moulds are typically of a fixed length and shape.

For concrete casting of larger structures, the mould walls are usually thick facings, which may be reinforced by steel beams and the like, in order to withstand the substantial weight of the fluid concrete mixture prior to curing, thus resulting in heavy and bulky formwork moulds that require auxiliary (often motorised) equipment, such as cranes, to erect. The joining of the mould halves is also time-consuming, due to the precision required in their location.

Known structures also tend to be relatively expensive to manufacture, due to the strength requirements of the materials employed.

Whilst in many building structures, such as houses, apartment blocks and the like, ceiling heights are standardised, many applications exist where columns or pillars are used that require structures of variable height. In order to cast such columns or pillars using re-usable formwork components, it is necessary to stack, brace and cross-fasten a plurality of mould halves if a single cast operation is to be performed. Alternatively, incremental height casting may be employed, i.e. a first length of pillar is cast and a subsequent length portion is cast onto the previous one after the lower portion has set, using the same mould. However, this is a time-consuming, and consequently expensive, method.

Spirally formed plastic, steel & cardboard tubing has also been used in the casting of round concrete pillars or casting concrete within a fibrous cement tube. However, the inside surface of cardboard tubing usually renders a low-grade finish of the cast structure, which requires further surface finishing to be performed on the cast pillar. Existing spirally wound tubing used for casting is also generally circular in section, making it unsuitable for casting pillars with other cross-sections.

Columns of square cross-section are typically cast in moulds constructed from ply wood facings with timber or steel external reinforcing, or similar materials. This method of construction also tends to be labour and time consuming and dimensional accuracy of successive pillar castings is not always ensured due to the need of erecting formwork from scratch each time a pillar is cast.

Australian Patent No. 696707 by Ezytube Pty Ltd discloses a composite tube and method of manufacturing thereof. The tube consists of a foamed, tubular core with inner and outer surface liners. The tube can be formed to define a pillar-like casting cavity with a desired cross-section (e.g. circular, square, polygonal); the casting formwork is assembled from components with desired cross-sections. The continuous outer liner of the composite tube is designed to withstand the hoop-stress resulting from filling of the internal cavity of the tubular mould, thereby providing a strong, yet light-weight component which can be used to cast concrete columns of quite substantial height.

One drawback of this type of formwork tubing is that once the concrete (or other casting material) has set, the peripherally closed tubular formwork has to be radially cut and pulled from the cast pillar or column. Formwork tubing that has been cut in this manner cannot be re-used without an additional bracing mantle, since the exterior lining that provides hoop strength for the formwork has been breached. As the tubing formwork disclosed in this patent is relatively expensive in comparison with more traditional methods of forming concrete columns, it would be advantageous to provide an alternate construction of similar type which would enable the formwork to be reused, thereby reducing overall casting costs.

Such a formwork is disclosed in Australian Patent no. 784695 by Ezytube Pty Ltd. This formwork is designed to have individual core segments, adapted to define a moulding cavity, which can be individually peeled away from the column when set. These are held in place via a binding which is wrapped around the formwork and secures by a locking or clamping device.

However, this formwork system can, in some circumstances, be difficult to install, due to the need to have the mould core segments stand in place while securing the binding. It would also be desirable to provide a formwork which does not require ancillary equipment, such as clamps, to secure it in a rigid operational state.

Typically tubular forms for casting round, square and rectangular columns are not re-usable on the building site by non skilled workers. Some systems such as disclosed in WO2006/024677 require significant ancillary equipment to be available to reinstate the outside reinforcing structure, which in most cases is difficult to satisfactorily locate at the work site where it is needed, and therefore requires additional transport, time and cost considerations.

Accordingly, it is an object of the present invention to provide a modular formwork system that represents an appreciable improvement over the systems of the prior art.

### SUMMARY OF THE INVENTION

According to one aspect of the invention, there is provided a concrete formwork tube, said tube including: an internal lining; an external lining; and two or more complementary mould segments adapted to be received between said external and internal lining, each mould segment having an inner face and an outer face; said mould segments, when assembled and substantially restrained by the external lining from relative movement, defining a moulding cavity open towards an upper and a lower end of the formwork; and at least one locking segment, said locking segment adapted to be disposed between two of said mould segments, thereby to tighten the fit of the assembled mould segments inside the external lining.

One advantage of embodiments in accordance with the invention as summarised above, as compared with the prior art, is that the described use of the locking segment allows the main parts of the formwork to be arranged in position in a relatively loose-fitting manner in between the internal and external linings, whilst the relatively easy insertion of the locking segment provides the final tightening of the mould segments inside the external lining, thereby producing the relatively rigid structure required of the formwork tube when in use.

A further advantage is that each of the individual mould segments, as well as the external lining, can be transported and stored flat, greatly reducing the space required for the parts. The other main advantage of the concrete formwork tube according to the invention is that the components are able to be disassembled in a non-destructive manner, allowing re-use of the components.

A role of the internal lining in embodiments of the invention is to provide the desired surface finish for the column, as well as to seal the concrete inside the mould while it is in a liquid state, and preferably to facilitate the mould surface's release from the concrete after pouring.

According to another aspect of the invention, there is provided a concrete formwork tube, said tube including: an internal lining; an external lining; two or more complementary mould segments received between said external and internal lining, each mould segment having an inner face and an outer face and two engaging edges; and at least one locking segment, having an inner face and an outer face and two engaging edges, said engaging edges adapted to make sealing contact with the engaging edges of the mould segments; wherein said mould segments define a moulding cavity open towards an upper and a lower end of the formwork and are restrained by the external lining from relative movement; and wherein the locking segment or segments are disposed in between said mould segments such that the engaging edges of the locking segment or segments are in sealing engagement with the engaging edges of the mould segments; and wherein the presence of said locking segments causes the outer faces of the assembled mould segments to be forced against the external lining.

This aspect of embodiments of the invention provides all of the advantages described above, with the further advantage that the design of the edges of the mould segments and locking segments are provided such that they will not permit egress of unset concrete from the moulding cavity.

Preferably, the locking segment as defined above has an inward face and an outward face, the inward face being disposed toward the moulding cavity and the outward face being disposed toward the external lining; wherein said outward face is adapted to form a continuous curvature substantially matching the outer curvature of the assembled mould segments. This allows the outer surface of the combined assembled mould and locking segments to present a smooth curvature in contact with the inner surface of the external lining, which allows the external lining to spread its compressive force evenly throughout its length.

Preferably, the locking segment features, in profile, a neck region; the surfaces of said neck region being disposed to contact the edge of two adjacent mould segments; and wherein the width of the neck region is less than the width of the inner face of the locking segment, but is adapted to allow relatively easy insertion of said mould segments into said outer lining.

Preferably, said inner lining is a film, sheet or coating attached to the inner face of said mould segments, and said outer lining is a sleeve adapted to fit around the mould segments. The outer lining is preferably constructed substantially from paper, plastic or metal. Advantageously, the outer lining is constructed substantially of flexible material such that the sleeve will lay flat when not acting as part of the tube structure.

According to another aspect of the invention, there is provided a method of manufacturing a concrete column, including the steps of: assembling a concrete formwork tube according to any preceding claim; positioning said tube at the required location for the column; pouring concrete into said moulding cavity; allowing said concrete to set; and dismantling and removing said concrete formwork tube.

The method according to the invention provides a usefully simplified manner of constructing the formwork tube manually, with a relatively lower level of operator skill required and no requirement for the use of ancillary tools, as the insertion of the locking segment effectively induces a rigid, free-standing, state in the tube.

According to another aspect of the invention, there is provided a kit for the assembly of a concrete formwork tube, said kit including: an internal lining; an external lining; and two or more complementary mould segments sized for reception between said external and internal lining, each mould segment having an inner face and an outer face; at least one locking segment, said locking segment adapted to be disposed in between two of said mould segments; and instructions to assemble said mould segments in between said internal and external lining to define a moulding cavity open towards an upper and a lower end of the formwork; and to insert said locking segment in between two of said mould segments, thereby to tighten the fit of the assembled mould segments inside the external lining.

A further advantage of the formwork tube according to the invention is that the basic components may be dismantled after pouring, re-used where possible and reassembled on site to create additional columns using the original components. The internal liner may be reused where a lower quality concrete finish is appropriate (such as concealed or covered columns); the mould segments should be able to be reused several times; the locking segment should be able to be reused several times; the external layer would typically be discarded after each use, unless a clamped, outer wrap type is used.

According to another aspect of the invention, there is provided a concrete formwork tube, said tube including: an internal surface; an external lining; and two or more complementary mould segments adapted to be received inside said external lining, each mould segment having an inner face and an outer face; said mould segments, when assembled and substantially restrained by the external lining from relative movement, defining a moulding cavity open towards an upper and a lower end of the formwork, said inner surface being defined by said inner faces; and at least one locking segment, said locking segment adapted to be disposed between two of said mould segments, thereby to tighten the fit of the assembled mould segments inside the external lining; wherein said internal surface is formed by the inner faces of the mould segment material. Now will be described, by way of a specific, non-limiting example, a preferred embodiment of the invention.

### BRIEF DESCRIPTION OF THE DRAWINGS

FIG. 1 is a schematic plan view of a concrete formwork tube according to the invention.

FIG. 2 is a schematic detail plan view of a locking segment as included in a concrete formwork tube according to the invention, and as shown in FIG. 1.

FIG. 3 is a view of four adjoined mould segments and an outer lining which form part of a concrete formwork tube according to the invention.

FIG. 4 is a view of the mould segments of FIG. 3.

FIG. 5 is a view of the mould segments of FIG. 3 being inserted into the external lining of FIG. 3.

FIG. 6 is a view of a concrete formwork tube assembled from the parts of FIG. 3 in a state of partial assembly with the locking segment partially inserted.

FIG. 7 is a view of the concrete formwork tube of FIG. 6 in a state of partial assembly with the locking segment partially inserted.

FIG. 8 is a view of the concrete formwork tube of FIG. 6 in a state of partial assembly with the locking segment partially inserted.

FIG. 9 is a view of the concrete formwork tube of FIG. 6 in a state of partial assembly with the locking segment almost completely inserted.

FIG. 10 is a view of the concrete formwork tube of FIG. 6 fully assembled with the locking segment completely inserted.

### DETAILED DESCRIPTION OF A PREFERRED EMBODIMENT

The invention may be applied to a very wide variety of physical configurations, particularly in relation to the variety of column profiles which may be required to be moulded using a formwork according to the invention.

The fundamental form of the invention is one in which two or more mould segments are constrained inside a, preferably flexible, external lining, and wherein at least one locking element is inserted between the edges of at least two of the mould elements. In practice, the insertion of the locking segment forces the outer sides of the mould segments against the inside of the external lining so that a tight fit is created, which in turn provides rigidity to the structure.

There are a myriad of different numbers and profiles of the mould segments and locking segments which can form part of the formwork tube. It is preferred that the mould segments at least are formed from a light but strong material, such as polystyrene foam, polyurethane foam, paper or plastic honeycomb, which can be extruded, moulded, cut or formed into the required shapes that when they are assembled internally of the external lining creates the desired internal shape. They may alternatively be formed as, or incorporate, an inflatable bag.

The profile of the mould segments dictate the desired shape of the mould cavity internally and the profile of the mould assembly externally. Typically, the outer profile will be rounded (e.g. circular), such that when the mould segments are assembled the mould will have a cylindrical appearance, which allows the outer layer of material to exert reasonable even restraining pressure throughout its circumference. The locking segment may also be composed of wood, plastic polystyrene foam, or metal (e.g. aluminium), or other suitable polymer materials.

The outer lining should preferably be a continuous cylinder of strong, flexible material. It must offer the required mechanical properties to ensure: resistance to burst when filled with concrete; resistance to damage from impact or wear from movement of the form on site (e.g. by crane, manual handling and/or freight/transportation); resistance to weather damage (rain, UV light, wind, heat, humidity). It may be constructed from paper, plastic, steel spiral tube, woven or non-woven mesh tubing or may preferably be a flexible tube that can lay flat for shipping and form a circular profile after insertion of the mould segments and key (locking segment). It may also be a flexible wrap secured by clamps or an equivalent securing mechanism.

The inner lining may be a separate continuous sheet, having a tubular or box-like structure, or may be attached piecewise to the inner surface of the mould segments. It may be composed of any suitable material that will not adhere to concrete, including plastic, paper, timber, steel or composites thereof. Alternatively, it may be formed integrally with the inner face of the mould segments.

The following is an illustrative example, designed to illustrate the principle of the invention, which the skilled addressee will immediately appreciate is applicable to all of the alternative embodiments discussed above.

Turning to FIG. 1, there is shown a plan view of a set of four mould segments arranged as per a fully assembled concrete formwork tube, for moulding a fundamentally square profile column having chamfered corners. Two of the four mould segments (5, 10) are identical, while the other two mould segments (15, 20), which each have one edge (25, 30) adapted to connect with a locking segment 35, are similar in all other respects.

An external lining (not shown) would wrap tightly around the outer surfaces 40 of said mould segments. An internal lining would be provided around the inner surfaces 45 of the mould segments and at the outer edge of the internal moulding cavity 50.

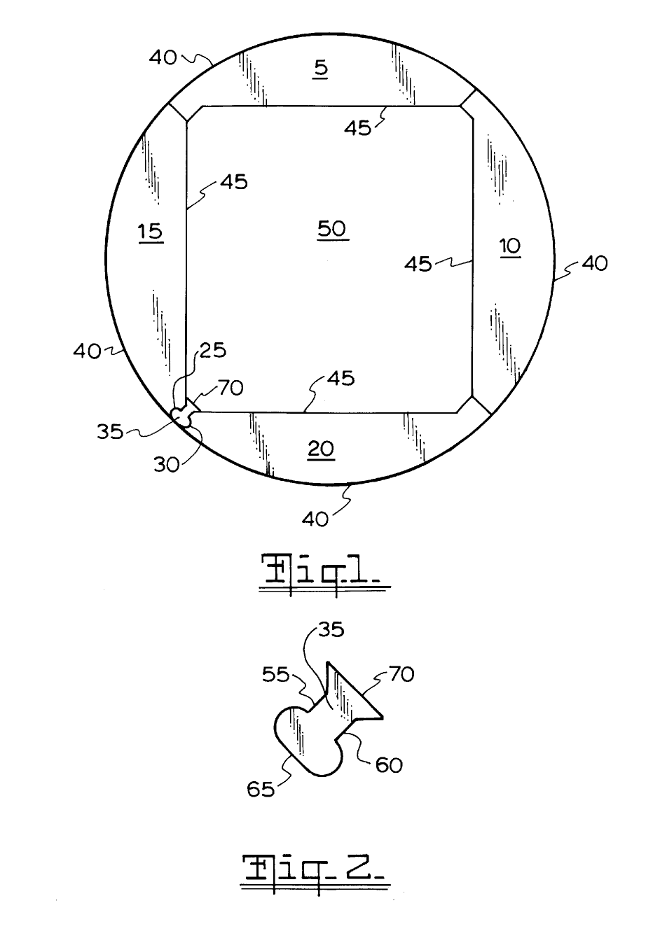

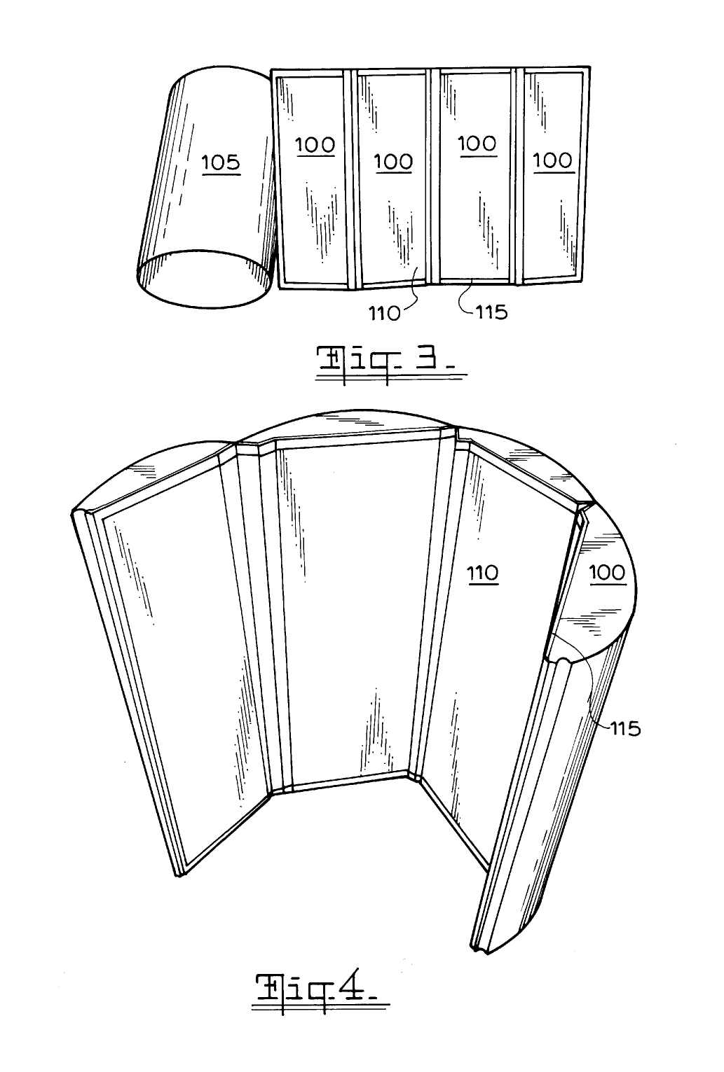

FIG. 2 shows a detail view of the locking segment 35 shown in FIG. 1. It will be noted that in both FIGS. 1 and 2 that the side edges (55, 60) of the locking segment, and the edges (25, 30) of the adjacent mould segments (15, 20), each have complementary form-fitting profiles which prevent relative movement of the components once assembled. This is to ensure the locking segment 35 is held securely in place, resisting the high internal pressure which may be developed when the mould cavity 50 is filled with concrete.

The locking segment 35 also features as flat face 70 which is adapted to form part of the internal lining of the moulding cavity 50.

The locking segment 35 also features an angled rear face 75 which is designed to overlap the mould segments preventing forward movement of the mould segments, and also sealing this corner from concrete leakage.

It is a particularly advantageous feature of the locking segment that its overall profile configuration includes a ‘neck’ region, shown as the region defined between the side edges (55, 60). This configuration allows the locking segment to be held in place particularly securely. Where the relative width of this neck is as shown in FIG. 2, this provides a particular advantage in that the mould segments can be inserted into the outer lining more readily. Preferably, the locking segment features, in profile, a neck region; the surfaces of said neck region being disposed to contact the edge of two adjacent mould segments; and wherein the width of the neck region is less than the width of the inner face of the locking segment, but is adapted to allow relatively easy insertion of said mould segments into said outer lining. If the neck of the locking segment is too thin, it will be too difficult to insert the mould segments.

It will be noted that the angled rear faces 75 are adapted to make sealing contact with the relevant edges of the mould segments 100, which also improves the sealing of the gap(s) between mould segments that is/are filled by the locking segment 35.

It will also be noted that the outer surface 65 of the locking segment 35 is curved to match the curvature of the outer surfaces 40 of the mould segments. This is to ensure an even application of pressure on the external lining when in place.

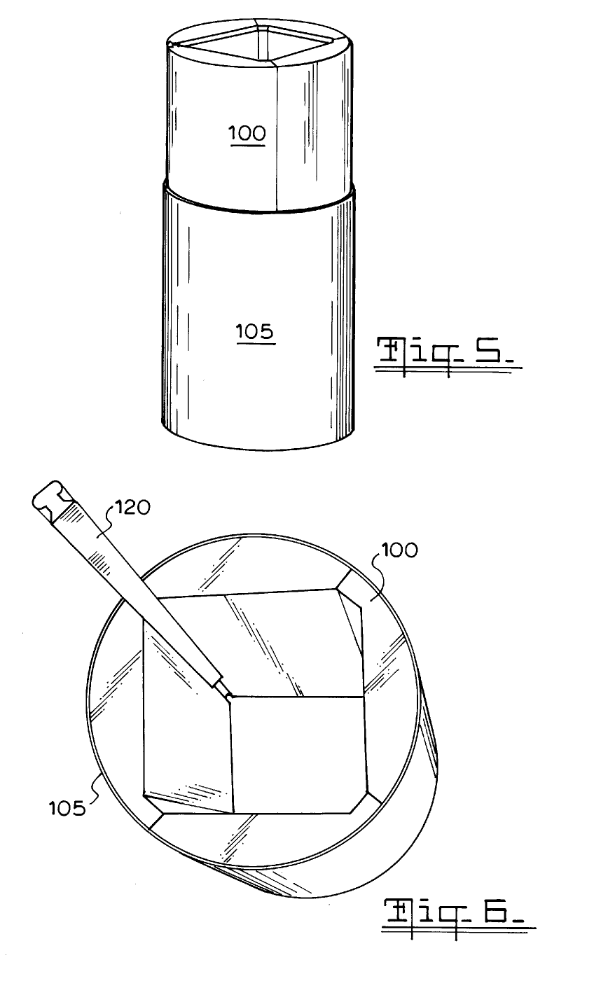

Turning to FIG. 3, there is shown a set of four mould segments 100 and an external lining tube 105. The mould segments 100 are adjoined at the edges, as shown in further detail in FIG. 4. The inner lining 110 is affixed to the inner faces 115 of the mould segments 100. Alternatively, the mould segments may be separate pieces prior to being inserted into the external lining tube.

FIG. 5 shows the folded set of mould segments 100 being easily inserted into the external lining tube 105.

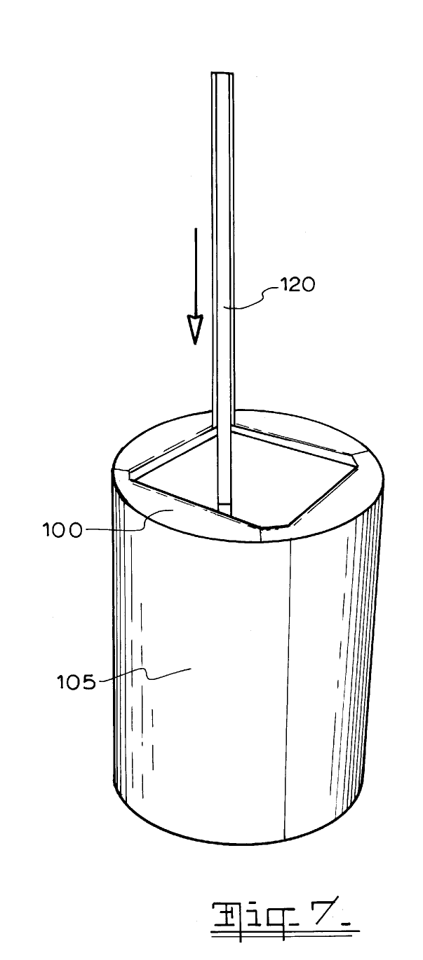

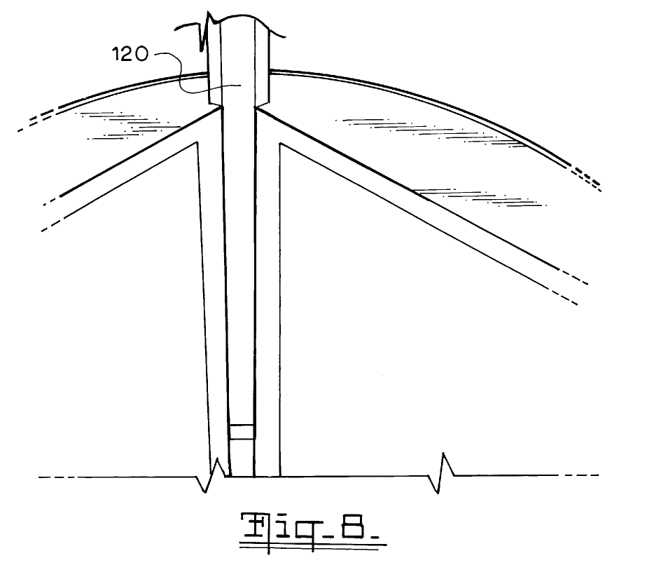

FIG. 6 shows an end view of the mould segments 100 completely inserted into the external lining tube 105, and with a locking segment 120 partially inserted into the gap between the unattached edges of the mould segments. FIG. 7 illustrates that the locking segment 120 can be manually inserted into this gap.

FIG. 8 shows the partially inserted locking segment 120 in greater detail. It will be noted that, in this particular case, the inner surface 125 of the locking segment 120 features an affixed portion of the inner lining. However, this surface may be provided in other ways if desired.

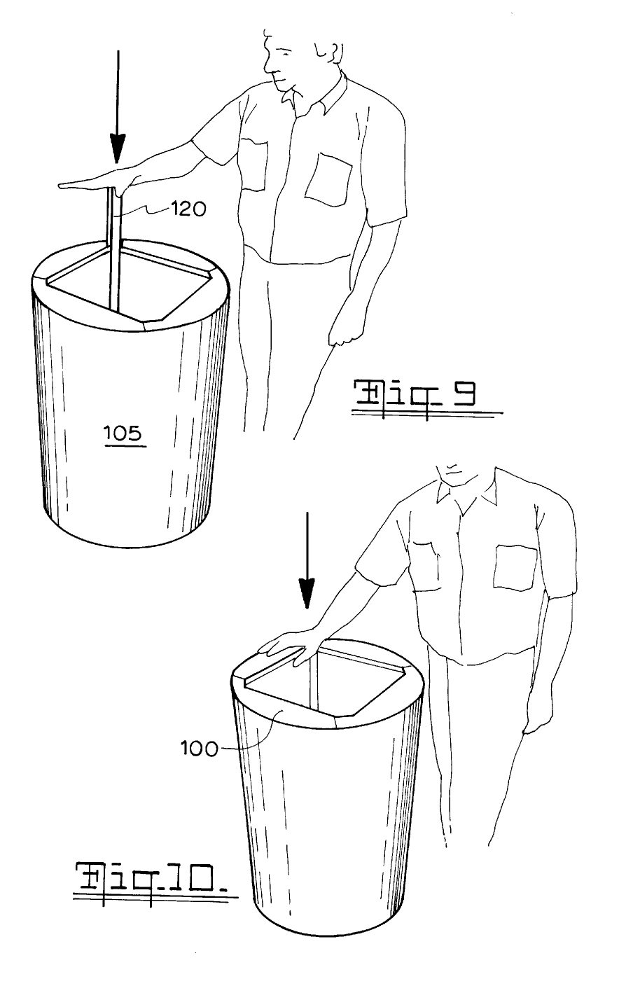

FIG. 9 shows the locking segment 120 almost completely inserted, and FIG. 10 shows the locking segment 120 completely inserted, thereby completing the assembly of a now-rigid concrete formwork tube according to the invention.

In construction of a concrete column using the concrete formwork tube illustrated above, wet concrete would now be poured into the cavity formed in the centre of the tube. The concrete would set and the external lining would be removed. The mould segment could then be peeled away from the newly formed column.

It will be appreciated by those skilled in the art that the above are merely examples of how the invention may be put into practice. There are many other physical configurations possible, which while different in some details, would nevertheless fall within the spirit and scope of the invention.

1. A concrete formwork tube, said tube including:
an internal lining;
an external lining; and
two or more complementary mould segments, adapted to be received between said external and internal lining; each mould segment having an inner face and an outer face; said mould segments, when assembled and substantially restrained by the external lining from relative movement, defining a moulding cavity open towards an upper and a lower end of the formwork; and
at least one locking segment, said locking segment adapted to be disposed between two of said mould segments, thereby to tighten the fit of the assembled mould segments inside the external lining.

2. A concrete formwork tube, said tube including:
an internal lining;
an external lining;
two or more complementary mould segments received between said external and internal lining, each mould segment having an inner face and an outer face and two engaging edges; and
at least one locking segment, having an inner inward face and an outer outward face and two engaging edges, said engaging edges adapted to make sealing contact with the engaging edges of the mould segments;
wherein said mould segments define a moulding cavity open towards an upper and a lower end of the formwork and are restrained by the external lining from relative movement; and
wherein the locking segment or segments are disposed in between said mould segments such that the engaging edges of the locking segment or segments are in sealing engagement with the engaging edges of the mould segments; and
wherein the presence of said locking segment or segments causes the outer faces of the assembled mould segments to be forced against the external lining.

3. The concrete formwork tube of claim 1, wherein the locking segment has an inward face and an outward face, the inward face being disposed toward the moulding cavity and the outward face being disposed toward the external lining; wherein said outward face is adapted to form a continuous curvature substantially matching the outer curvature of the assembled mould segments.

4. The concrete formwork tube of claim 3, wherein the locking segment or segments feature, in profile, a neck region; the surfaces of said neck region being disposed to contact the edge of two adjacent mould segments; and wherein the width of the neck region is less than the width of the inward face of the locking segment, but is adapted to allow relatively easy insertion of said mould segments into said external lining.

5. The concrete formwork tube of claim 1, wherein said internal lining is a film, sheet or coating attached to the inner face of said mould segments; and wherein said external lining is a sleeve.

6. The concrete formwork tube of claim 5, wherein said external lining is constructed substantially from paper, plastic, metal, woven or non woven tubing.

7. The concrete formwork tube of claim 5, wherein said external lining is constructed substantially of flexible material such that the sleeve will lay flat when not part of the tube structure.

8. A kit for the assembly of a concrete formwork tube, said kit including:
an internal lining;
an external lining; and
two or more complementary mould segments sized for reception between said external and internal lining, each mould segment having an inner face and an outer face;
at least one locking segment, said locking segment adapted to be disposed in between two of said mould segments; and
instructions to assemble said mould segments in between said internal and external lining to define a moulding cavity open towards an upper and a lower end of the formwork; and to insert said locking segment in between two of said mould segments, thereby to tighten the fit of the assembled mould segments inside the external lining.

9. A concrete formwork tube, said tube including:
an internal surface;
an external lining; and
two or more complementary mould segments adapted to be received inside said external lining, each mould segment having an inner face and an outer face; said mould segments, when assembled and substantially restrained by the external lining from relative movement, defining a moulding cavity open towards an upper and a lower end of the formwork, said inner surface being defined by said inner faces; and
at least one locking segment, said locking segment adapted to be disposed between two of said mould segments, thereby to tighten the fit of the assembled mould segments inside the external lining;
wherein said internal surface is formed by the inner faces of the mould segment material.

10. A method of manufacturing a concrete column, including the steps of:
assembling a concrete formwork tube as defined in any preceding claim;
positioning said tube at the required location for the column;
pouring concrete into said moulding cavity;
allowing said concrete to set; and
dismantling and removing said concrete formwork tube.

11. (canceled)

12. (canceled)

13. (canceled)

14. (canceled)

15. A locking segment for assembling mould segments of a concrete formwork tube, said locking segment including:
an inward face;
an outward face; and
a neck region connecting the inward and outward faces, wherein the width of the neck region is less than the width of the inward face and the neck region defines two engaging edges adapted to make sealing contact with respective engaging edges of a pair of mould segments received and assembled by said locking segment;
wherein the outward face is adapted to form a continuous curvature substantially matching an outer curvature of the assembled pair of mould segments.

16. The concrete formwork tube of claim 2, wherein the inward face of the at least one locking segment is disposed toward the moulding cavity and the outward face of the at least one locking segment is disposed toward the external lining; wherein said outward face is adapted to form a continuous curvature substantially matching the outer curvature of the assembled mould segments.

17. The concrete formwork tube of claim 16, wherein the locking segment or segments feature, in profile, a neck region; the surfaces of said neck region being disposed to contact the edge of two adjacent mould segments; and wherein the width of the neck region is less than the width of the inward face of the locking segment, but is adapted to allow relatively easy insertion of said mould segments into said external lining.

18. The concrete formwork tube of claim 2, wherein said internal lining is a film, sheet or coating attached to the inner face of said mould segments; and wherein said external lining is a sleeve.

19. The concrete formwork tube of claim 18, wherein said external lining is constructed substantially from paper, plastic, metal, woven or non woven tubing.

20. The concrete formwork tube of claim 18, wherein said external lining is constructed substantially of flexible material such that the sleeve will lay flat when not part of the tube structure.
